(19) United States
(12) Patent Application Publication
(10) Pub. No.: US 2011/0089389 A1
(43) Pub. Date: Apr. 21, 2011

(54) LAWN MOWER LIFT

(76) Inventor: MELVIN WEBER, Paradise Hill (CA)

(21) Appl. No.: 12/906,109

(22) Filed: Oct. 17, 2010

Related U.S. Application Data
(60) Provisional application No. 61/253,069, filed on Oct. 20, 2009.

(51) Int. Cl. B66F 5/04; B66F 3/24; B66F 7/22

(52) U.S. Cl. 254/3 B; 254/93 R

(57) ABSTRACT

A lifting apparatus for a small vehicle which includes a two-wheeled base frame assembly. A support frame assembly is for retaining the small vehicle thereon. The support frame assembly is pivotally mounted at a rear end to a rear end of the base frame assembly. A hydraulic lift assembly is positioned between the base frame assembly and the support frame assembly. When the hydraulic lift assembly is manually activated, the support frame assembly will be raised at an angle upwardly from the base frame assembly, to allow a person to perform maintenance and repairs to the underside of the small vehicle.

### CROSS-REFERENCE TO RELATED APPLICATION

This application claims the benefit of Provisional Patent Application No. 61/253,069, filed on Oct. 20, 2009, in the United States Patent & Trademark Office, the disclosure of which is incorporated herein by reference.

### BACKGROUND OF THE INVENTION

1. Field of the Invention

The present invention relates to a vehicle elevating mechanism, and more particularly, a lifting apparatus for a small vehicle.

The present invention provides easy access to the underside of small vehicles, such as riding lawnmowers and all terrain vehicles. The lifting apparatus allows users to perform general maintenance and cleaning of the small vehicles safely and efficiently. Anyone who owns riding lawnmowers and all terrain vehicles, will appreciate the convenience that the present invention provides. It eliminates the need to remove the mowing deck on the riding lawnmowers to clean the cutters and can assist in prolonging the life of the all terrain vehicles by allowing for easy maintenance.

2. Description of the Prior Art

After cutting grass, it is beneficial to clean the compacted grass out from the cutters of the riding lawnmower as soon as possible. Attempting to remove the mowing deck to access the cutters can be tedious and time consuming. It also can result in damage to the riding lawnmower. It is often necessary to perform maintenance on the riding lawnmower or an all terrain vehicle. Neglecting to maintain the equipment can reduce the life of the equipment. Cleaning debris out of the riding lawnmower can assist in decreasing the spread of lawn diseases. An easier method of accessing the underside of the small vehicles is needed.

Numerous innovations for small vehicle lifting devices have been provided in the prior art that will be described. Even though these innovations may be suitable for the specific individual purposes to which they address, however, they differ from the present invention.

A FIRST EXAMPLE, U.S. Pat. No. 3,779,517, issued on Dec. 18, 1973, to Fisher teaches a frame and jack assembly, the frame being substantially rectangular shaped and including spaced apart vehicle supporting tracks and spaced apart, transverse track supporting cross frame members connecting the tracks together, the jack including a forwardly extending, vertically movable lifting structure, the cross frame members secured to the lifting structure for movement therewith to elevate a vehicle supported on the tracks to a position to facilitate the performance of work thereon.

A SECOND EXAMPLE, U.S. Pat. No. 4,549,721, issued on Oct. 29, 1985, to Stone teaches a chassis member of a small garden tractor, riding lawn mower or like vehicle that is engaged by the free ends of a transversely spaced apart set of lifter arms pivoted at their opposite ends on the upper end of an upstanding end stand carried adjacent one end of a base frame of a sufficient longitudinal span to inhibit tilting upon the application of a load to the ends of the lifter arms. Lifting force is applied to the lifter arms by an upwardly extending screw actuated scissors jack seated at its lower end on the base frame and pivotally connected at its upper end to a lifter bar bridging between the lifter arms inwardly of their free ends through a pivotable connecting link forming with the scissors jack an expandable toggle linkage. The end of each lifter arm is preferably longitudinally bifurcated and an adapter is preferably supplied therefore for engagement with different configurations of chassis members, the adapter being so designed as to be wedged in place on the lifter arm end by the weight of the load being lifted.

A THIRD EXAMPLE, U.S. Pat. No. 5,678,804, Issued on Oct. 21, 1997, to Lintelman et al. teaches a lifting or jacking device for the lifting of lawn mowing equipment comprising an axle with wheels, an extended vertical element secured to the axle, a support element secured to the axle at approximately a 90 degree angle from the extended vertical element, and a gripping piece, preferably a pair of gripping teeth secured to one end of the support bar. Preferably a foot assist bar is also secured to the extended vertical element to assist the lever element in raising the lawn mowing equipment. In addition, there is preferably secured to the device an extendable safety arm which is extendable from the support element to maintain the lifting device in a fixed position after the lawn mowing equipment has been lifted. Also preferably, the extended lever bar is divided into an upper and lower section, the upper section of which may be rotated to assist in the movement and storage of the lifting or jacking device.

A FOURTH EXAMPLE, U.S. Pat. No. 5,826,857, Issued on Oct. 27, 1998, to Brack et al. teaches a commercial mower support stand which includes a cradle at its top that is adapted to engage a lifting bar that is secured to the front or rear end of a lawn mower, golf cart, or other light vehicle. The cradle is supported by a plurality of upstanding rigid legs that are secured at their respective lowermost ends to a base plate. A pair of laterally spaced apart support legs, support a forward end of the base plate and a pair of laterally spaced apart wheels support the rearward end of the base plate when the stand is in its upright position on a support surface. A tube mounted at a predetermined angle to the base plate slidingly receives an elongate leverage handle that is used to manipulate the stand as needed when lifting and lowering a pre-selected end of a light vehicle. The stand includes storage receptacles for the leverage handle, replacement mower blades, a lubrication gun, or other items and tools.

A FIFTH EXAMPLE, U.S. Pat. No. 5,971,360, Issued on Oct. 26, 1999, to Sinsley teaches a lifting and support device for elevating self-propelled lawn mowers or lawn tractors comprising, a support frame having wheels with adjustable equipment engagement and stabilization brackets extending therefrom. An activation bar handle extending from the support frame in an angular relation thereto so that the elevated lawn mower equipment moves past a vertical lift line for stabilization.

A SIXTH EXAMPLE, U.S. Pat. No. 6,015,254, issued on Jan. 18, 2000, to Keeler teaches a snowmobile dolly comprising a first elongated member; a plurality of wheels disposed along the first elongated member; a second elongated member; a mount for securing the second elongated member relative to the first elongated member so that a longitudinal axis of the first elongated member and the second elongated member are substantially parallel to each other, the second elongated member being sized so as to support a front end of the snowmobile; a third elongated member having a first end portion which is attached to an end of the first elongated member; and a hook for securing a back end of the snowmobile to the third elongated member so as to substantially balance the snowmobile on the second elongated member.

A SEVENTH EXAMPLE, U.S. Pat. No. 6,330,997, issued on Dec. 18, 2001, to McGlaun et al. teaches a lifting apparatus for small vehicles, including a frame assembly, a pair of fabric webs attached to the frame assembly, and a pivotable lift assembly with a pair of spaced-apart wheel holders for receiving and securing the forward wheels of a vehicle such as a lawn or garden tractor, golf cart, or the like. To use the apparatus, the operator positions the wheels of the vehicle on the webs, operably positions the forward wheels in the wheel holders, then drives the vehicle over the webs while the lift assembly pivots upwards . The weight of the vehicle holds the webs in place on the ground, thereby causing the frame and lift assemblies to lift and pivot, raising the apparatus from a first stable position (the “down” position) to a second stable position (the “up” position) where the undercarriage of the vehicle is accessible for servicing and maintenance.

AN EIGHTH EXAMPLE, U.S. Pat. No. 6,345,807, issued on Feb. 12, 2002, to Cacciatore teaches a small vehicle lift generally consisting of a base assembly and a lift platform assembly secured to each other by a pivot pin located at one end of the base within the anti-tilt extension members. The lifting action of the platform is angular to the base and is accomplished through a hydraulic lifting device which is pivotally anchored to the base as well as to the lifting platform structure a short distance from the main lift pivot point. When actuated, the hydraulic lift forces the rotation of the platform about the pivot pin to a maximum 60 degree displacement. Additionally, there is a safety pin mounted on the elevated rear portion of the base that slides in and out and that acts as a safety device in case of hydraulic jack failure when the lift is in full up position. This allows for easy and safe access to the underside of the mower for maintenance and repair.

A NINTH EXAMPLE, U.S. Pat. No. 6,474,625, issued on Nov. 5, 2002, to Bevre teaches a lawn tractor maintenance system for safely elevating a lawn mower for examination and maintenance. The lawn tractor maintenance system includes a frame, a pair of wheel supports attached to the frame, and a lever arm attached to the frame for allowing an individual to manipulate the frame and wheel supports. A chain is attached to each of the wheel supports for securing the tires of the lawn tractor within the wheel supports during manipulations. The wheel supports and the lever arm are preferably removably attached to the frame for allowing compact storage thereof.

A TENTH EXAMPLE, U.S. Pat. No. 6,474,626, issued on Nov. 5, 2002, to Box teaches a lawn mower rack that is formed of a structural base for resting on a support surface. First and second spaced apart longitudinal rails supported by the base and adapted to receive wheels of a lawn mower thereon. A first manually operated lifter is provided for elevationally supporting rearward portions of the longitudinal rails above the base and a second manually operated lifter, independent of the first lifter, is provided for elevationally supporting forward portions of the longitudinal rails above the base so that thereby only approximately one half of the weight of a lawn mower need be lifted at a time.

AN ELEVENTH EXAMPLE, U.S. Pat. No. 7,111,444, Issued on Sep. 26, 2006, to Morris et al. teaches a lawn tractor lift consisting of a lift arm having a forward end and a rearward end, a tire wheel receiving cradle pivotally mounted upon the forward end of the lift arm; a lever arm having a forward end and a rearward end, and a curved bar providing a variable fulcrum, the curved bar having a forward end and a rearward end, and a pivot point, the rearward end of the curved bar being fixedly attached to or formed wholly with the forward end of the lever arm, the forward end of the curved bar being fixedly attached to or formed wholly with the rearward end of the lift arm, the curved bar, upon alternate levering and counter-levering of the lever arm, alternately rearwardly and forwardly moving the pivot point.

A TWELFTH EXAMPLE, U.S. Pat. No. 7,278,627, Issued on Oct. 9, 2007, to Jones teaches a lift and support structure for a lawn tractor which includes a frame with a center lift member secured to and separating a pair of wheel support members. Ramps are secured to the wheel support members to permit the front or rear wheels of the lawn tractor to be rolled onto or off of the lift and support structure. The center lift member is elevated above the wheel support members to permit a floor jack or other lifting mechanisms to be placed under the lift and support structure. A pair of support legs may be locked in a raised position to support the lawn tractor for safe and easy access to the underneath side of the tractor, and may be pivoted or folded to the side when the lift and support structure is in a lowered position.

It is apparent now that numerous innovations for small vehicle lifting devices have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a lifting apparatus for a small vehicle that avoids the disadvantages of the prior art.

ANOTHER OBJECT of the present invention is to provide a lifting apparatus for a small vehicle that is simple and inexpensive to manufacture.

STILL ANOTHER OBJECT of the present invention is to provide a lifting apparatus for a small vehicle that is simple to use.

BRIEFLY STATED, STILL YET ANOTHER OBJECT of the present invention is to provide a lifting apparatus for a small vehicle which comprises a base frame assembly. A support frame assembly is for retaining the small vehicle thereon. The support frame assembly is pivotally mounted at a rear end to a rear end of the base frame assembly. A hydraulic lift assembly is positioned between the base frame assembly and the support frame assembly. When the hydraulic lift assembly is manually activated the support frame assembly will be raised at an angle upwardly from the base frame assembly, to allow a person to perform maintenance and repairs to the underside of the small vehicle.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a rear perspective view of the present invention showing a riding lawnmower secured thereto in a raised position;

FIG. 2 is a side perspective view taken in the direction of arrow 2 in FIG. 1;

FIG. 3 is a bottom perspective view taken in the direction of arrow 3 in FIG. 2, showing a person performing maintenance to the riding lawnmower;

FIG. 4 is a front perspective view of the present invention, showing an all terrain vehicle secured thereto in a raised position; and

FIG. 5 is a side perspective view showing the present invention in a collapsed position ready to be transported.

### REFERENCE NUMERALS UTILIZED IN THE DRAWING

110 lifting apparatus
112 small vehicle
114 base frame assembly of apparatus 110
116 support frame assembly of apparatus 110
118 rear end of support frame assembly 116
120 rear end of base frame assembly 114
122 hydraulic lift assembly of apparatus 110
124 person
126 lower horizontal side rail of base frame assembly 114
128 lower horizontal side rail of base frame assembly 114
130 lower horizontal end rail of base frame assembly 114
132 lower horizontal end rail of base frame assembly 114
134 upper angular side rail of base frame assembly 114
136 upper angular side rail of base frame assembly 114
138 vertical leg of base frame assembly 114
140 vertical leg of base frame assembly 114
142 track of support frame assembly 116
144 track of support frame assembly 116
146 cross beam of support frame assembly 116
148 loading ramp of support frame assembly 116
150 loading ramp of support frame assembly 116
152 tie-down chain of support frame assembly 116
154 extension track of support frame assembly 116
156 extension track of support frame assembly 116
158 hook on extension track 154
160 hook on extension track 156
162 inverted channel member of hydraulic lift assembly 122
164 floor jack of hydraulic lift assembly 122
166 rectangular plate member of hydraulic lift assembly 122
168 flip-up safety rod of hydraulic lift assembly 122
170 flip-up safety rod of hydraulic lift assembly 122
172 axle of base frame assembly 114
174 wheel unit of base frame assembly 114
176 wheel unit of base frame assembly 114
178 hitch member of base frame assembly 114

### DETAILED DESCRIPTION OF THE PREFERRED EMBODIMENT

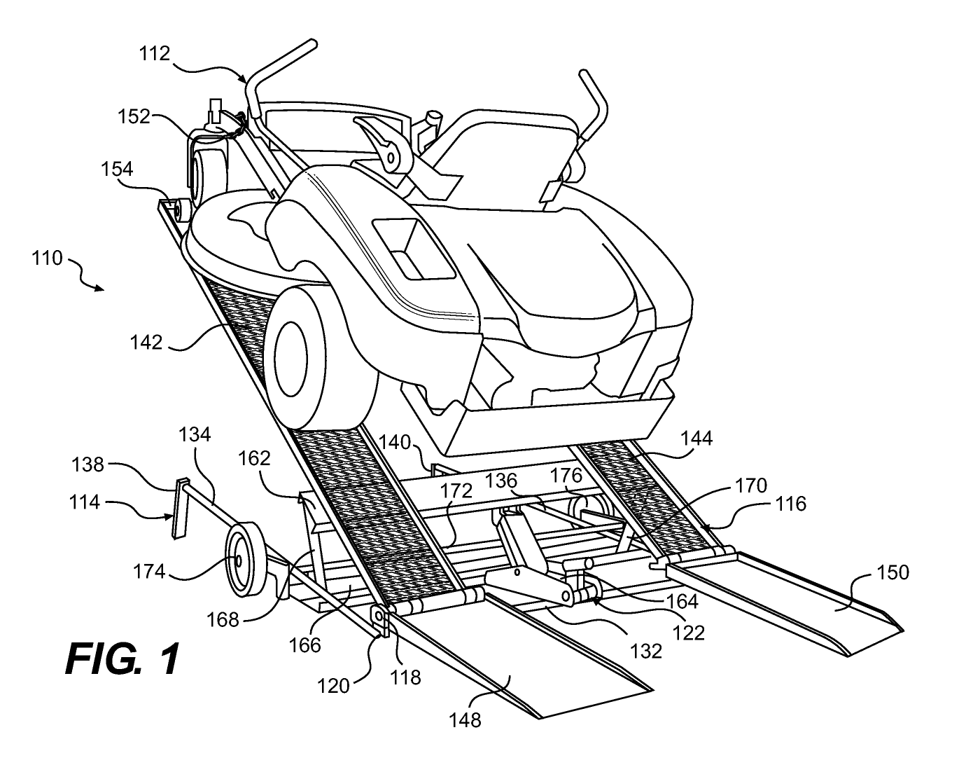

Referring now to the figures, in which like numerals indicate like parts, and particularly to FIGS. 1 through 5, and as such, will be discussed with reference thereto.

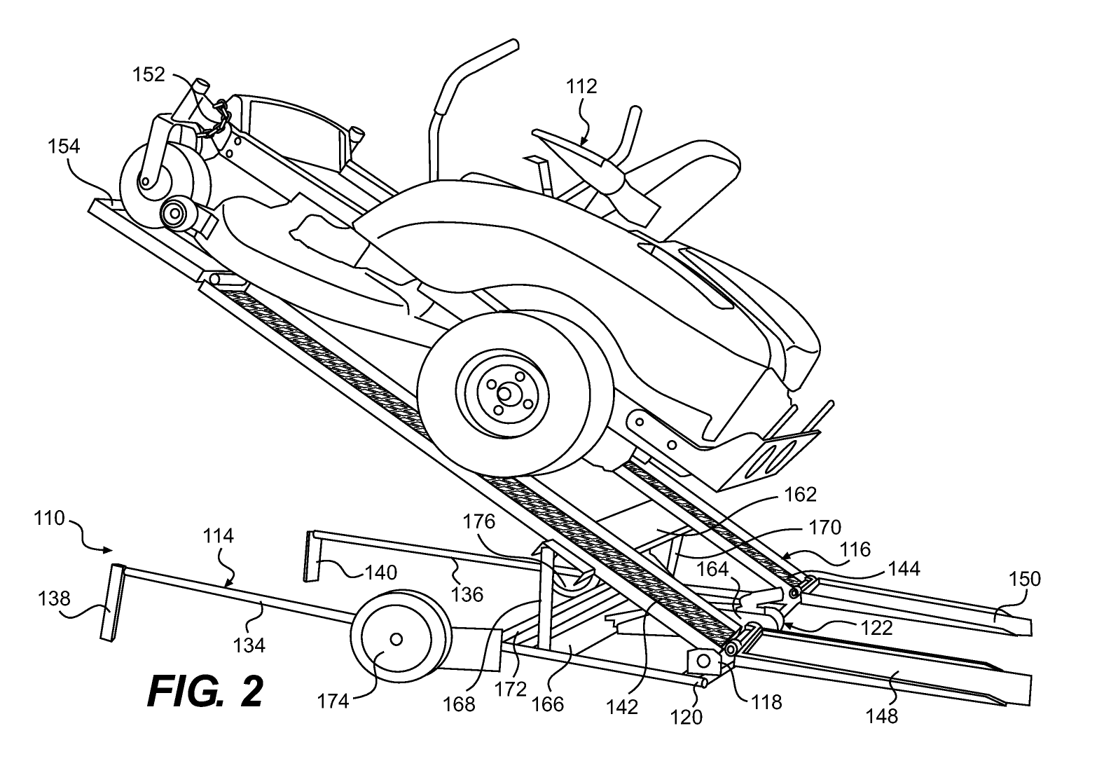

As shown in FIG. 1: a lifting apparatus 110 is provided for a small vehicle 112. The lifting apparatus 110 comprises a base frame assembly 114. A support frame assembly 116 is for retaining the small vehicle 112 thereon. The support frame assembly 116 is pivotally mounted at a rear end 118 to a rear end 120 of the base frame assembly 114. As shown in FIG. 2: a hydraulic lift assembly 122 is positioned between the base frame assembly 114 and the support frame assembly 116. When the hydraulic lift assembly 122 is manually activated by the user, the support frame assembly 116 will be pivotally raised at an angle (˜30 degrees) upwardly from the base frame assembly 114, to allow a person 124 to perform maintenance and repairs to the underside of the small vehicle 112.

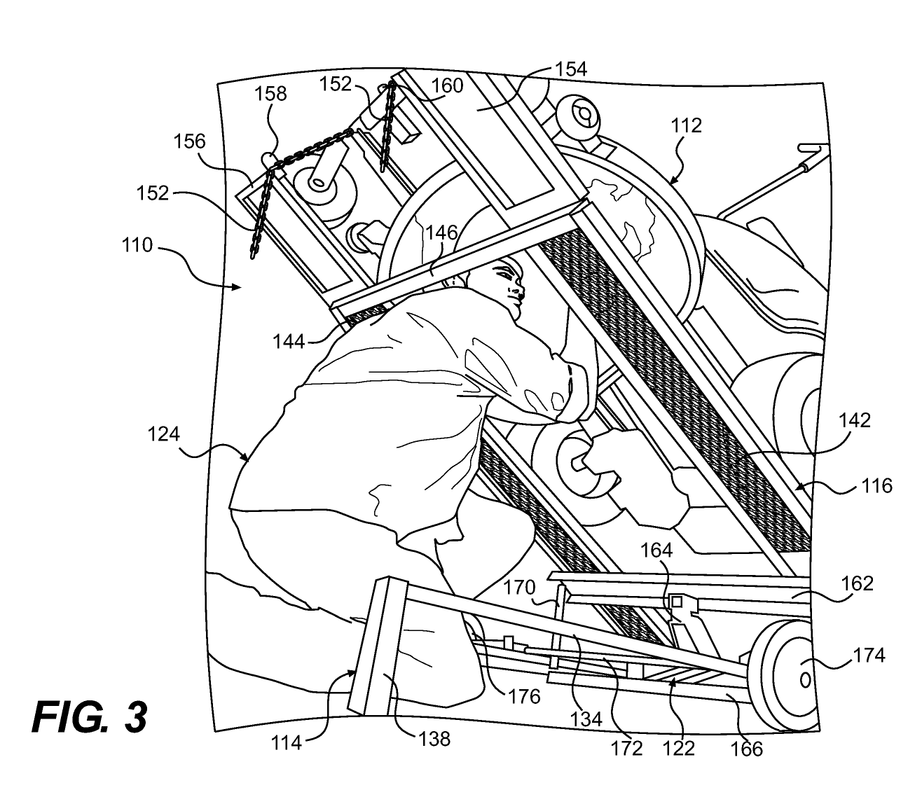

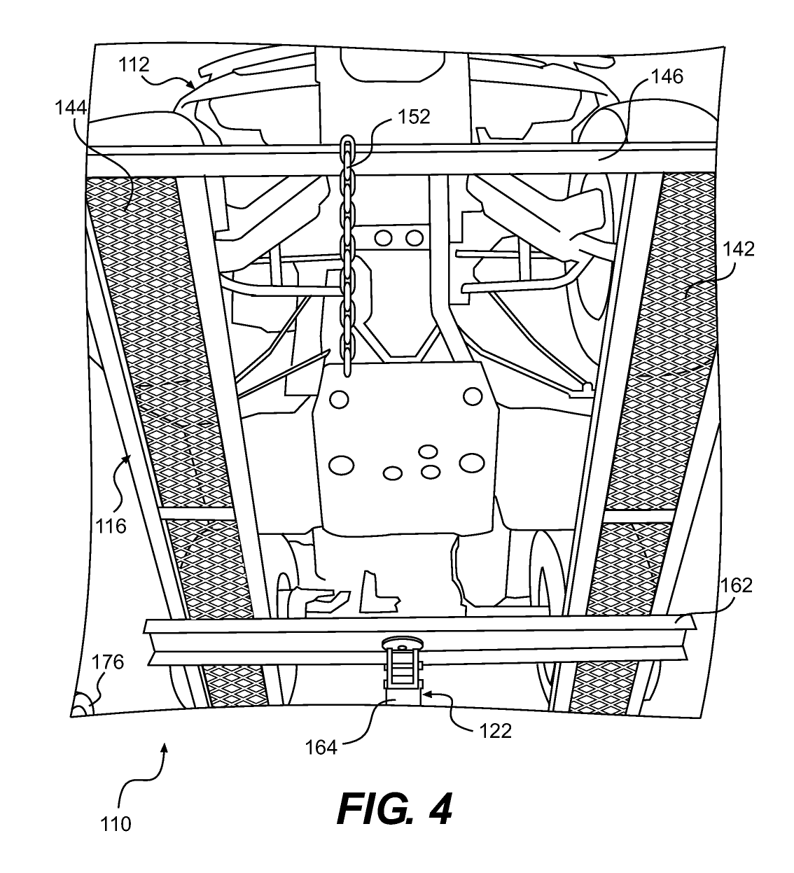

As shown in FIGS. 3-4: The support frame assembly 116 comprises a pair of tracks 142,144 to receive tires of the small vehicle 112. A cross beam 146 is mounted between front ends of the tracks 142,144. A pair of loading ramps 148,150 is each pivotally mounted to a rear end of each track 142,144. Two tie-down chains 152 are affixed between the cross beam 146 and the small vehicle 112.

The support frame assembly 116 further comprises a pair of extension tracks 154,156 that are each removably mounted at a rear end to a front end of each track 142,144. A pair of hooks 158,160 is each affixed to a front end of each extension track 154,156 to engage with one tie-down chain 152 coming from the small vehicle 112.

The hydraulic lift assembly 122 comprises an inverted channel member 162 extending across and mounted to underside of the pair of tracks 142,144. A floor jack 164 is positioned to engage with the inverted channel member 162. A rectangular plate member 166 extends across and affixed at opposite ends to the underside of the lower horizontal side rails 126,128 of the base frame assembly 114. A pair of flip-up safety rods 168, 170 is on the rectangular plate member 116 to engage with the inverted channel member 162.

The base frame assembly 114 further comprises an axle 172 extending between the lower horizontal side rails 126,128. Two wheel units 174,176 are each pivotally mounted to one end of the axle 172. The wheel units 174,176 can be placed in a raised position to allow the small vehicle 112 to be loaded onto the support frame assembly 116. The wheel units 174,176 can be placed in a down position for moving the base frame assembly 114. A hitch member 178 is attached to the front lower horizontal end rail 130. When the wheel units 174,176 are in the down position and the support frame assembly 116 is in a collapsed position, the apparatus 110 can be towed by the hitch member 178.

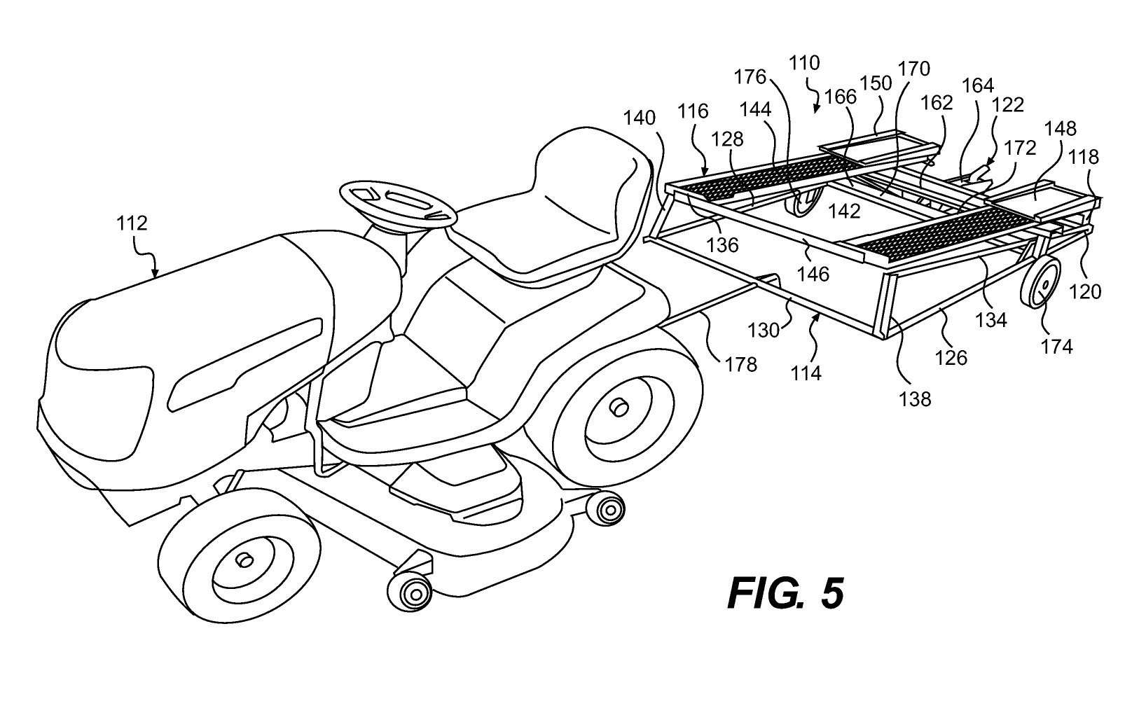

As shown in FIG. 5: the base frame assembly 114 comprises a pair of lower horizontal side rails 126, 128. A pair of lower horizontal end rails 130,132 is each affixed to an extend between the lower horizontal side rails 126, 128. A pair of upper angular side rails 134,136 is each affixed to a rear end of each lower horizontal side rail 126,128. A pair of vertical legs 138,140 is each affixed between a front end of each lower horizontal side rail 126,128 and a front end of each upper angular side rail 134,136.

In summary, the lift apparatus 110 enables the person 124 to reach the underside of the small vehicle 112 being a riding lawnmower or an all terrain vehicle with ease. The present invention consists of the two flip-down loading ramps 148,150 made from expanded metal and an angle iron. Metal slide-in extension tracks 154,156 are also included in the front of the apparatus 110. The base frame assembly 114 is made from a one inch steel rod. The floor jack 164 is situated at the base frame assembly 114 of the apparatus 110 under the inverted channel member 162. There are two wheel units 174,176 connected to the base frame assembly 114 to allow for mobility. The axle 172 for the wheel units 174,176 are specifically configured to allow the wheel units 174,176 to be positioned in a raised position, for loading the small vehicle 112 and in a down position for moving the apparatus 110. Safety rods 168,170 are also included and are made from one inch solid steel. There are also tie-down chains 152 included to secure the small vehicle 112 to the support frame assembly 116.

To use the apparatus 110, unfold the loading ramps 148,150 at the rear of the tracks 142,144 and drive the small vehicle 112 onto the support frame assembly 116, stopping when the front tires of the small vehicle 112 reach the front of the tracks 142,144. Put the small vehicle 112 into park and dismount. Apply the tie-down chains 152 around the front axle of the small vehicle 112 and cross beam 146 of the support frame assembly 116. Take a lever and place it in the floor jack 164. Begin to lift until the support frame assembly 116 reaches full height. Then, flip up the safety rods 168,170 on either side of the floor jack 164. Then, the user begins the maintenance. When ready to lower the support frame assembly 116, kick in the safety rods 168,170, twist the handle of the floor jack 164 counter clockwise, and the support frame assembly 116 lowers. Then, the user reverses the loading procedure. To move the apparatus 110, flip up the loading ramps 148,150 at the rear of the tracks 142,144 place the wheel units 174,176 into the down position the support frame assembly 114 in the collapsed position. The apparatus 110 is now ready to be moved for storage. The present invention can accommodate a variety of small vehicles 112 such as Zero-Turn lawn tractor, All Terrain Vehicle (ATV), snowmobile, . . . etc. . . . The exact specifications may vary.

It will be understood that each of the elements described above, or two or more together, may also find a useful application in other types of constructions differing from the types described above.

While the invention has been illustrated and described as embodiments of a lifting apparatus for a small vehicle, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A lifting apparatus for a small vehicle which comprises:
a) a base frame assembly;
b) a support frame assembly for retaining the small vehicle thereon, the support frame assembly pivotally mounted at a rear end to a rear end of the base frame assembly; and
c) a hydraulic lift assembly, positioned at rear end between the base frame assembly and the support frame assembly, whereby when the hydraulic lift assembly is manually activated to pivotally raise the support frame assembly at an angle upwardly from the base frame assembly to allow a person to perform maintenance and repairs to underside of the small vehicle.

2. The apparatus as recited in claim 1, wherein the base frame assembly comprises:
a) a pair of lower horizontal side rails;
b) a pair of lower horizontal end rails, each affixed to and extending between the lower horizontal side rails;
c) a pair of upper angular side rails, each affixed to a rear end of each the lower horizontal side rail; and
d) a pair of vertical legs, each affixed between a front end of each the lower horizontal side rail and a front end of each the upper angular side rail.

3. The apparatus as recited in claim 1, wherein the support frame assembly comprises:
a) a pair of tracks to receive tires of the small vehicle;
b) a cross beam mounted between front ends of the tracks;
c) a pair of loading ramps, each pivotally mounted to a rear end of each the track; and
d) two tie-down chains affixed between the cross beam and the small vehicle.

4. The apparatus as recited in claim 3, wherein the support frame assembly further comprises:
a) a pair of extension tracks, each removably mounted at a rear end to a front end of each the track; and
b) a pair of hooks, each affixed to a front end of each the extension track to engage with one the tie-down chain coming from the small vehicle.

5. The apparatus as recited in claim 1, wherein the hydraulic lift assembly comprises:
a) an inverted channel member extending across and mounted to underside of the pair of tracks;
b) a floor jack positioned to engage with the inverted channel member;
c) a rectangular plate member extending across and affixed at opposite ends to underside of the lower horizontal side rails of the base frame assembly; and
d) a pair of flip-up safety rods on the rectangular plate member to engage with the inverted channel member in order to prevent the collapse of the support frame assembly.

6. The apparatus as recited in claim 2, wherein the base frame assembly further comprises:
a) an axle extending between the lower horizontal side rails; and
b) two wheel units each pivotally mounted to one end of the axle, wherein the wheel units can be placed in a raised position to allow the small vehicle to be loaded onto the support frame assembly and the wheel units can be placed in a down position for moving the base frame assembly.

7. The apparatus as recited in claim 1, wherein the base frame assembly further comprises a hitch member attached to the front lower horizontal end rail, whereby when the wheel units are in the down position and the support frame assembly is in a collapsed position, the apparatus can be towed via the hitch member.

8. The apparatus as recited in claim 1, wherein the angle is approximately thirty degrees.
